(19) United States
(12) Patent Application Publication
(10) Pub. No.: US 2010/0104861 A1
(43) Pub. Date: Apr. 29, 2010

(54) METAL-FORMING TOOLS COMPRISING CEMENTED TUNGSTEN CARBIDE AND METHODS OF USING SAME

(76) Inventors: David Richard Siddle, Greensburg, PA (US); Irene Spitsberg, Export, PA (US)

Correspondence Address: KENNAMETAL INC.;Intellectual Property Department, P.O. BOX 231, 1600 TECHNOLOGY WAY, LATROBE, PA, 15650, US

(21) Appl. No.: 12/257,966

(22) Filed: Oct. 24, 2008

(51) Int. Cl. B32B 9/04; C04B 14/48; B21D 31/00

(52) U.S. Cl. 428/336; 428/698; 106/640; 428/328; 252/62.55; 72/364

(57) ABSTRACT

Metalforming tools comprising WC—Co cemented tungsten carbide are provided for warm and/or hot working operations. The WC—Co materials have controlled compositions and microstructures, resulting in properties that allow the material to be used in such warm and hot metalworking applications.

### FIELD OF THE INVENTION

The present invention relates to metal forming tools, and more particularly relates to cemented tungsten carbide tools that are used to form metals at elevated temperatures.

### BACKGROUND INFORMATION

Dies and other tools used in metalforming processes such as forging, extruding, stamping and drawing are subject to wear which represents one of the major issues affecting productivity in the metalforming industry. In metalforming processes, a metal work piece is plastically deformed by pressing, squeezing or hammering forces—usually at temperatures ranging from ambient to 1,300° C. The surfaces of the forming tools, such as dies, punches and extrusion rams, are typically made of H13 steel or other types of tool steel that comes into contact with the work piece. Such tools experience significant mechanical and thermal loadings, resulting in significant wear of the tools. The wear becomes especially severe in higher temperature ranges, e.g., above 600° C., where steel exhibits a rapid drop in strength as well as hardness. This results in surface plastic deformation and galling leading to accelerated wear of the tool leading to loss of the shape and dimensional tolerances of the forgings. Even though many material solutions have been tried to improve the die wear, the problem still remains.

Various material solutions for the die wear problem have been tried. More expensive, heat resistant alloys such as Hastelloy and Inconell have found limited use in some applications, but they are expensive relative to the performance improvement and often suffer from early degradation due to thermal shock and surface cracking. Cemented carbides and other cermet systems have been described, e.g., Metals Handbook, Volume 2, 10th Edition, “Properties and Selection”, and U.S. Pat. No. 4,228,673. Some cemented carbides are used in the low temperature applications. However, in higher temperature ranges, e.g., warm and hot forging above 500° C., carbides are not commonly used, as the application of room temperature lubricants to the warm and hot dies usually results in high thermal shock leading to premature failure of the carbides due to their limited thermal shock resistance compared with metal alloys. An additional problem with cemented carbides at temperature at above 600° C. is accelerated oxidation, resulting in accelerated wear of the die or other tool. Modification of the binder alloy to achieve better strength and oxidation properties has been attempted, e.g., in EP 0 062 311 B1, where a Co matrix strengthened with Ni₃Al intermetallic phase is proposed. However, a high metallic content is required at levels of about 20 wt % in order to achieve higher fracture toughness at the expense of wear resistance.

Use of ceramics, such as silicon nitride, sialons and toughened zirconias, have been proposed, e.g., U.S. Pat. No. 3,807,212, U.S. Pat. No. 3,901,061, U.S. Pat. No. 4,228,673, DE 19951586, JP 620552176, JP 7100574 and JP 60180639. Ceramic inserts are typically assembled by shrink fitting and are kept under compressive stresses. Soldered connections have been described as an alternative solution for applications with tool geometries requiring the tip of the forming die to be exposed (such as in punch or ram) where the shrink fitting might not provide an adequate solution. Ceramics have high oxidation resistance, hot hardness and strength, as well as lower coefficients of friction, as compared to metal alloys and cermets. They are also relatively resistant to material transfer by diffusion at elevated forging temperatures, which contributes to their wear resistance. However, ceramics are brittle and have relatively low fracture toughness. As a result, ceramics have not been successfully used in high stress metalforming applications, where shear, low tension and impact loads can occur.

### SUMMARY OF THE INVENTION

Present invention provides metalforming tools having contact surfaces made of a WC—Co material with controlled composition and microstructure useful for metalforming applications, such as warm and/or hot forging, extrusion and rolling, where the workpiece temperature is above 500° C. or 600° C. The tools provide the needed combination of properties that allow the material to be used in such applications, where it has been common industry experience that cemented carbides are usually not suitable.

An aspect of the present invention is to provide a warm temperature metal forming tool having a metal forming surface comprising cemented tungsten carbide, wherein the cemented tungsten carbide consists essentially of from 86 to 95 weight percent WC grains and from 5 to 14 weight percent Co between the WC grains, and a mean free path between adjacent WC grains is greater than 0.5 micron.

Another aspect of the present invention is to provide a method of metal forming comprising forming a metal workpiece at an elevated temperature above 500° C. with a tool comprising cemented tungsten carbide, wherein the cemented tungsten carbide consists essentially of from 86 to 95 weight percent WC grains and from 5 to 14 weight percent Co between the WC grains, and a mean free path between adjacent WC grains is greater than 0.5 micron.

These and other aspects of the present invention will be more apparent from the following description.

### BRIEF DESCRIPTION OF THE DRAWINGS

FIG. 1 is a partially schematic side view of a forging assembly including die and punch tools comprising cemented tungsten carbide in accordance with an embodiment of the present invention.

FIG. 2 is a partially schematic illustration of the microstructure of a cemented tungsten carbide material in accordance with an embodiment of the present invention, showing the grain size of the tungsten carbide particles and the spacing between adjacent tungsten carbide grains representing a mean free path between the grains.

FIG. 3 is a partially schematic sectional side view of a portion of a metal working tool comprising a cemented tungsten carbide substrate coated with a protective coating layer that is adhered to the substrate by a bonding layer in accordance with an embodiment of the present invention.

FIG. 4 is a photomicrograph of a WC—Co material in accordance with an embodiment of the present invention.

FIG. 5 is a photomicrograph of a WC—Co material having finer WC grain size and higher Co concentration than the material of FIG. 4.

### DETAILED DESCRIPTION OF PREFERRED EMBODIMENT

In accordance with the present invention, it has been found that high temperature cyclic thermal and mechanical loads coupled with the geometry of tools used for warm and hot forging, extrusion, rolling and the like, result in more complex stress states as compared to those in low temperature applications. Such stress states require the material of the tool or die to exhibit improved wear performance characteristics as well as other properties in order to withstand the thermal loads.

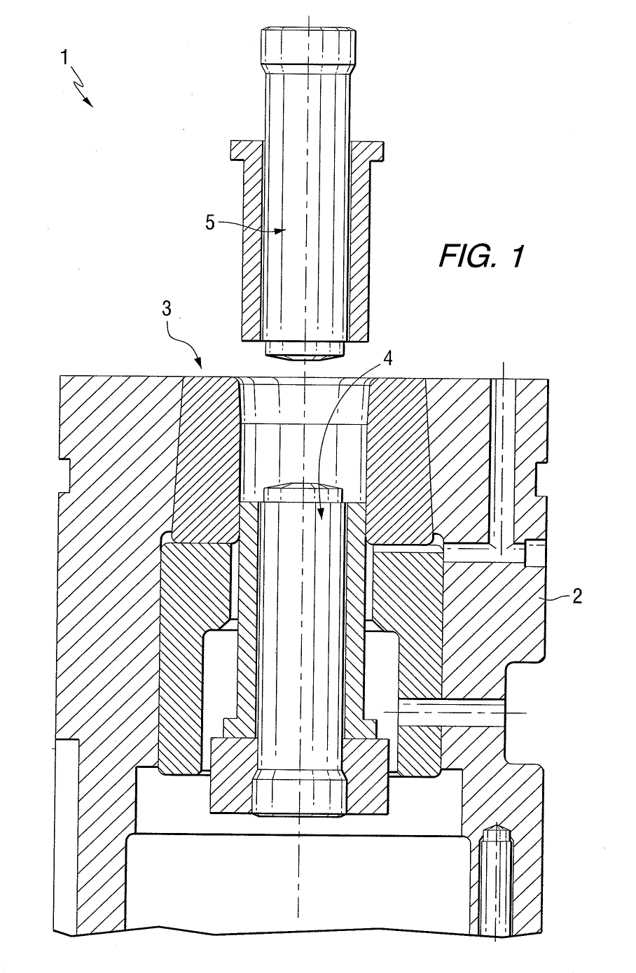

FIG. 1 illustrates a partially schematic side view of a forging assembly 1 including a conventional housing 2, a die 3, a lower punch tool 4 and an upper punch tool 5. In accordance with an embodiment of the present invention, at least portions of the die 3 and punch tools 4 and 5 are made of cemented tungsten carbide. The entire die 3 and punch tools 4 and 5 may be made of the present cemented tungsten carbide, or parts thereof may comprise the cemented tungsten carbide. For example, the tungsten carbide may be provided in selected high wear areas and may be attached to a backing material by any suitable means such as mechanical fasteners, shrink-fits, brazing, adhesives and the like.

The present WC—Co cemented carbide materials possess optimal combinations of fracture toughness, thermal properties, elastic modulus, tensile strength and shear strength characteristics. In addition, the materials exhibit good oxidation resistance in order to maintain these properties during the die service exposure.

In addition to the composition of the WC—Co material, the microstructure of the material has been found to have a critical effect on the mechanical properties. Both composition and microstructure play an important role in the oxidation rates as well. It has been found that unexpectedly improved properties are achieved when the material has a Co content between 5 and 10 wt %, a WC content between 90 and 95 wt %, and its microstructure is characterized by a mean free path of 0.7 micron or higher.

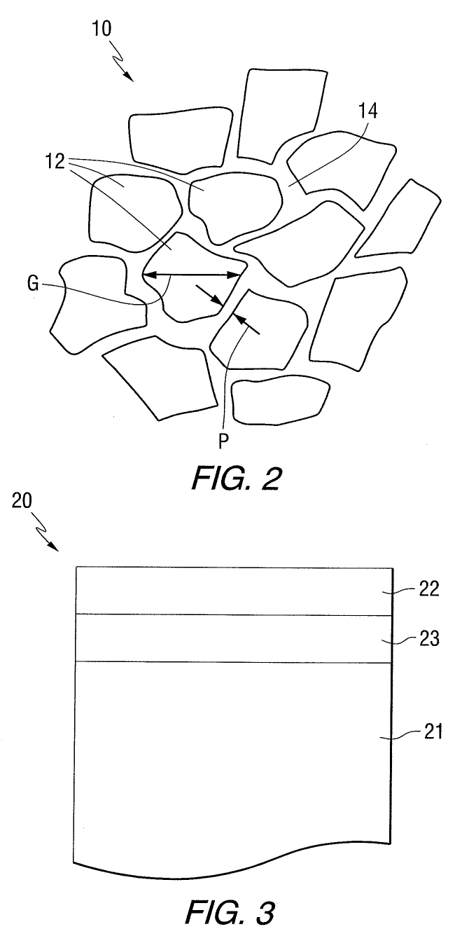

FIG. 2 schematically illustrates the microstructure of a WC—Co material 10 of the present invention. The material 10 includes WC grains 12 in a continuous Co matrix 14. The size of a WC grain is shown as G in FIG. 2, while the spacing between adjacent grains is labeled P. As more fully described below, the grain size G and spacing P are controlled in accordance with the present invention to provide a WC—Co material with unexpectedly improved properties for warm and hot metal working applications.

The mean free path between adjacent WC grains in the present materials is greater than 0.7 micron, typically from 0.9 to 1.4 micron. Such relatively large mean free paths improve mechanical properties of the WC—Co materials because larger mean free paths are known to correlate with higher fracture toughness, which is beneficial for the tool performance under mechanical loadings. However, when the free path exceeds certain limits, there is a drop in strength of the material. The strength is what determines the initiation of the cracks, and the fracture toughness is what controls the crack propagation under fatigue conditions. The thermo-mechanical fatigue is the failure mode which is characteristic of hot and warm forging applications as compared with cold forging applications. In accordance with the present invention, the mean free path (which is a function of Co content and grain size) is controlled in order to optimize the resistance to crack initiation and the resistance to crack propagation under fatigue conditions. In addition, larger mean free paths (above 1.4 micron) may result in lower hardness at fairly high temperatures than necessary for maintaining the desired wear resistance.

The mean free path of the cobalt binder may be measured either by a statistical approach using measured paths between the carbide particles or by calculations based on magnetic properties such as coercive force (Hc), density, and cobalt weight percentage. In general, a WC—Co material that exhibits a low Hc value (<130 oersteds) is characterized as having coarser WC grains and higher cobalt levels, providing increased toughness but lower hardness of the bulk material. One formula that has shown good correlation to measured mean free paths in WC—Co systems is:

2=[0.3(X)p/890−(Xp)]*[(80/Hc)^{(164.822/Xp)1/3}] in microns, where 2 is the mean free path in microns, X is the weight % of cobalt, p is the density in g/cc, and Hc is the coercive force in kA/m.

In certain embodiments, the WC—Co material is substantially free of certain metals such as Cr. As used herein, “substantially free” means that a metal or other material is not purposefully added to a material, but may be present in trace amounts or as an impurity. In another embodiment, optional metal additions such as Cr, V, Ta, Ti and/or Nb may be included in amounts up to 1 weight percent.

In certain embodiments, the WC has an average grain size of greater than 5 microns, typically from 7 to 25 microns. For example, the WC may have an average grain size of from 10 to 20 microns.

The present cemented tungsten carbide materials preferably have a magnetic coercivity of less than 100 oersteds, typically from 20 to 80 oersteds. For example, 50 to 60 oersteds may be preferred. Such relatively low magnetic coercivities improve mechanical properties of the WC—Co materials because they exhibit the optimal combination of toughness and hardness.

The present WC—Co materials typically have hardness of at least 83 HRA, for example, from about 84 to about 88.5 HRA.

The fracture toughness of the present WC—Co materials is typically at least 14, for example, from about 14 to about 20 MPa·in^{1/2}.

In accordance with embodiments of the present invention, the WC—Co materials are used in metal forming tools. Typical metal forming tools that are considered as sacrificial wear parts in such operations are dies, punches and rollers. Dies are generally thought of as the surrounding mold that provides the outside shape to the forged part. A punch is the member that provides the energy to the part and can also contribute to the shaping. These parts take on different roles in relation to the forming operation being considered. In upsetting operations, the dies provide the outer dimensional control to the formed part whereas the punch merely drives the billet under high loads to effectively shorten it while expanding the billet's cross sectional area. In forward extrusion operations, the dies again produce the outside geometry by reducing the cross sectional areas on the billet while the punch provides high loads that effectively lengthen the billet.

In these processes, the dies may be more prone to wear problems as compared to the punches. However, in backward extrusion operations, the punch not only delivers the required forces to the billet, but also shapes the inside geometry of the part, while the relation between the punch and the dies forms the wall thickness as the deformed billet flows back past the punch that is moving forward. In this back extrusion process, the punch and the die both see relative movement of the billet and are both prone to wear.

The dies used in these forming operations are typically cylindrical and axisymmetric in general form. This shape provides for several methods to promote the hard cermet material to be in contact with the high temperature billet material during the actual forming of the metal. One approach for promoting the cermet material to be in intimate contact with the billet material is to use an interference fit with the outer material being steel that is able to withstand the hoop tensile component, and the inside material being the cermet held in hoop and radial compression. Other attachment methods can include a brazed or soldered joint, adhesive bonding, or mechanical attachment.

The punches can have a variety of shapes and forms related to the process being used to form the billet shape. Often, these punches are flat platens used to push the billet into the dies, imparting no real shape to the billet. However, for back extrusion processes, the punch shapes the inside of the billet and is critical in maintaining the inside form and dimensions of the final part. Punches are often connected directly to the moving press frame by a simple threaded connection. In order to provide the hard cermet material in the wear zone in direct contact with the billet during forming, other means such as brazing or soldering, adhesive bonding, or mechanical attachment can be used.

Metal working tools made from the present WC—Co materials may be made entirely of the material, i.e., the WC—Co is provided as a monolithic material which comprises the entire tool. Alternatively, the present WC—Co materials may be provided as inserts, tiles, claddings and coatings on the wear surface of a tool substrate, wherein the substrate comprises any suitable resilient structured metal or alloy such as steel, superalloys and the like. In this embodiment, the thickness of the WC—Co insert or tile is typically at least 0.25 mm, for example, from about 0.5 to about 10 mm.

In some embodiments, the present WC—Co material may be provided as a coating on a tool substrate. WC—Co coating thicknesses of from 25 to 250 microns may be used.

The tool life of wear components such as dies and punches made out of the present WC—Co materials can be further improved during warm or hot metal-forming of a wide variety of metals and alloys (various steels, superalloys, etc.) by applying highly adherent protective coatings. Good adhesion can be typically characterized by scratch adhesion >50 N or indent adhesion >50 Kg. The use of a protective coating may provide a comparatively lower chemical interaction with the work-piece material. Such coatings work to prevent galling, and can introduce beneficial surface stresses.

FIG. 3 schematically illustrates a cross section of a portion of a metal working tool 20 comprising a substrate 21 made of cemented tungsten carbide as described above with a protective coating 22. The protective coating 22 is adhered to the substrate 21 by a bonding layer 23. The bonding layer 23 and protective coating 22 may be deposited in the substrate 21 by conventional techniques such as chemical vapor deposition (CVD), physical vapor deposition (PVD), or the like.

The protective coating 22 may include oxides such as aluminum oxide, zirconium oxide, magnesium oxide, chromium oxide, yttrium oxide, and compounds that are either composites (e.g., zirconia-aluminum composite) or alloys (yttrium-aluminum garnet) of these. Also, the protective coating 22 can be made of SiAlONs, silicon nitride, silicon carbide or composites comprising such materials. The bonding layer 23 may comprise any suitable material such as TiN, TiCN, TiC, TiN/TiCN, or the like. The thickness of each of the protective coating 22 and the bonding layer 23 typically ranges from 1 μm to 25 μm.

The following examples are intended to illustrate various aspects of the present invention, and are not intended to limit the scope of the invention.

### EXAMPLE 1

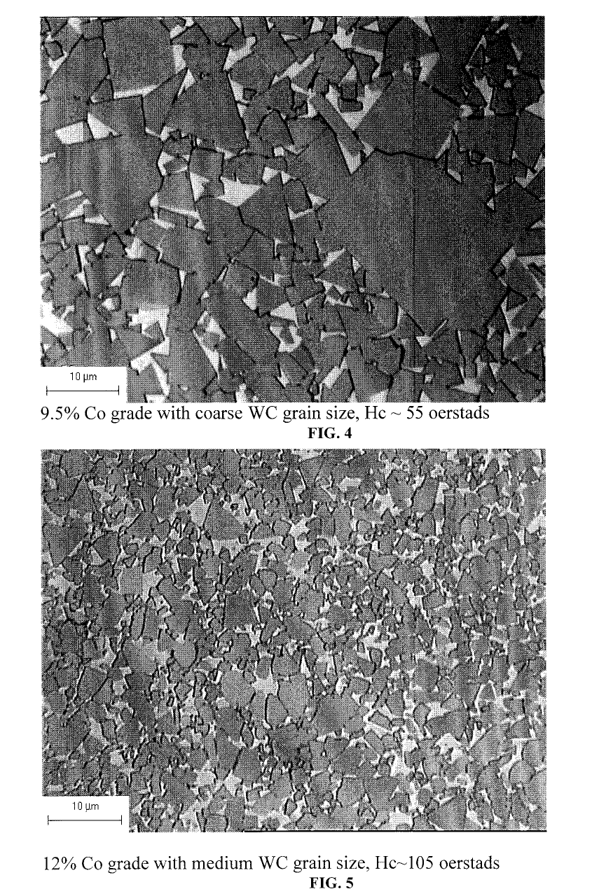

The material shown in FIG. 4 is made from a starting batch of tungsten carbide crystals, cobalt powder, and milling media such as tungsten carbide-cobalt cycloids, which are placed in a milling jar along with a solvent such as lacolene, and milling this mixture until the WC grains are at the desired grain size range and distribution. A green binding agent such as a wax is then added and blended in to provide a binding strength to the final powder. This slurry is then discharged from the milling jar and dried to remove the liquid solvent. The dried powder is processed to provide a flowable, agglomerated powder that contains the WC, cobalt, and the green binder. This powder is shaped into the net shape of the final part, delubed to remove the green binder, and sintered to provide the desired microstructure and mechanical properties of the WC-cobalt compound.

In the case of FIG. 4, this WC—Co compound uses a recipe to create a compound that contains 9.5 weight percent cobalt in a coarse WC grain structure in which the WC has an average grain size of about 10 μm. The mean free path between adjacent WC grains is 1.2 microns.

### EXAMPLE 2

In the case of the material create in FIG. 5, the same general processing steps outlined above are used, but different starting powders, ingredient ratios, and milling times are used to produce a less coarse tungsten carbide grain size (average grain size of about μm), higher cobalt level (12 weight percent) final powder, resulting in a final part that has a higher magnetic coercive force (105 oersteds) than the one produced in the material in FIG. 4 (55 oersteds). The mean free path between adjacent WC grains in the sample shown in FIG. 5 is 0.7 microns.

### EXAMPLE 3

WC—Co materials of the present invention were tested as follows. A die application was used to test the performance of several hard cermet materials during many forging cycles in an upsetting operation where the billet temperatures were about 800° C. The die was comprised solely of a hard cermet material chosen to provide extensive wear resistance as well as thermal shock resistance during the forging operation. Prior to the test, the cermet die was assembled in a two-piece steel container that imparted radial interference onto the outside surface of the die, resulting in sufficient radial compression to insure that the die's operating hoop stress was maintained as much as possible in the compressive regime. This assembly was placed onto a high tonnage hydraulic press. The upsetting operation cycle consisted of placing a hot billet at approximately 800° C. into the inside diameter of the cermet die, then applying a large axial force onto the billet to deform the cylindrical diameter to form a much larger flange at one location on the billet. The formed part was then ejected using an axial pin from the bottom that forced the deformed billet out of the die where it could be removed by the operator. The total time from insertion of the billet until removal by the operator was about 7 seconds.

The typical tool steel die used in this same operation was estimated to endure about 2,000-4,000 cycles prior to failure due to either excessive plastic deformation or wear at the location where the flange was formed. The tests using the cermet die produced a life of over 15,000 cycles prior to failure due to radial cracks forming in this same location. The test parts produced by this cermet die passed all quality control checks.

Whereas particular embodiments of this invention have been described above for purposes of illustration, it will be evident to those skilled in the art that numerous variations of the details of the present invention may be made without departing from the invention as defined in the appended claims.

1. A warm temperature metal forming tool having a metal forming surface comprising cemented tungsten carbide, wherein the cemented tungsten carbide consists essentially of from 90 to 95 weight percent WC grains and from 5 to 10 weight percent Co between the WC grains, and a mean free path between adjacent WC grains is greater than 0.7 micron.

2. The warm temperature metal forming tool of claim 1, wherein the mean free path is from 0.9 to 1.4 micron.

3. The warm temperature metal forming tool of claim 1, wherein the WC grains have an average size of greater than 5 micron.

4. The warm temperature metal forming tool of claim 1, wherein the WC grains have an average size of from 7 to 25 microns.

5. The warm temperature metal forming tool of claim 1, wherein the cemented tungsten carbide has a magnetic coercivity of less than 100 oersteds.

6. The warm temperature metal forming tool of claim 1, wherein the cemented tungsten carbide has a magnetic coercivity of from 20 to 80 oersteds.

7. The warm temperature metal forming tool of claim 1, wherein the WC comprises from 90 to 93 weight percent of the cemented tungsten carbide and the Co comprises from 7 to 10 weight percent of the cemented tungsten carbide.

8. The warm temperature metal forming tool of claim 1, wherein the cemented tungsten carbide further contains Ta, Cr and/or V in a total amount up to 5 weight percent.

9. The warm temperature metal forming tool of claim 1, wherein the cemented tungsten carbide has a hardness of at least 83 HRA, and a fracture toughness of at least 14 MPa·in^{1/2}.

10. The warm temperature metal forming tool of claim 1, wherein at least a portion of the cemented tungsten carbide is coated with a protective coating.

11. The warm temperature metal forming tool of claim 10, wherein the protective coating comprises aluminum oxide, zirconium oxide, magnesium oxide, chromium oxide, yttrium oxide, and composites or alloys thereof.

12. The warm temperature metal forming tool of claim 10, wherein the protective coating has a thickness from 1 μm to 25 μm thick.

13. The warm temperature metal forming tool of claim 1, wherein the tool comprises a forging die or punch.

14. A method of metal forming comprising forming a metal workpiece at an elevated temperature above 500° C. with a tool comprising cemented tungsten carbide, wherein the cemented tungsten carbide consists essentially of from 90 to 95 weight percent WC grains and from 5 to 10 weight percent Co between the WC grains, and a mean free path between adjacent WC grains is greater than 0.5 micron.

15. The method of claim 14, wherein the elevated temperature is from 600 to 1,300° C.

16. The method of claim 14, wherein the metal workpiece comprises steel, Ni-based superalloys, Co-based alloys, Ti-based alloys.

17. The method of claim 14, wherein the WC grains have an average size of greater than 5 micron.

18. The method of claim 14, wherein the WC grains have an average size of from 7 to 25 microns.

19. The method of claim 14, wherein the cemented tungsten carbide has a magnetic coercivity of less than 100 oersteds.

20. The method of claim 14, wherein the WC comprises from 90 to 93 weight percent of the cemented tungsten carbide and the Co comprises from 7 to 10 weight percent of the cemented tungsten carbide.

21. The method of claim 14, wherein the cemented tungsten carbide further comprises Ta, Cr and/or V in a total amount up to 1 weight percent.

22. The method of claim 14, wherein the cemented tungsten carbide has a hardness of at least 84 HRA, and a fracture toughness of at least 14 MPa·in^{1/2}.

23. The method of claim 14, wherein the tool comprises a forging die or punch.
